(19) United States
(12) Patent Application Publication
(10) Pub. No.: US 2006/0089909 A1
(43) Pub. Date: Apr. 27, 2006

(54) CARDLESS TRANSACTION SYSTEM

(75) Inventors: George A. McLeod, Langley (CA); Dana M. Woods, New Westminster (CA)

Correspondence Address: SEAN W. GOODWIN, 237- 8TH AVE. S.E., SUITE 360, THE BURNS BUILDING, CALGARY, AB, T2G 5C3, CA

(73) Assignee: FIRST NATIONAL TECHNOLOGIES INC., Vancouver (CA)

(21) Appl. No.: 10/908,908

(22) Filed: May 31, 2005

(30) Foreign Application Priority Data
Oct. 21, 2004 (CA) 2,485,881

(51) Int. Cl. G06Q 40/00

(52) U.S. Cl. 705/44

(57) ABSTRACT

A method of conducting cardless and cashless transactions is disclosed. A user, such as from a plurality of students of one or more clients or schools, presents a familiar user ID number and a PIN at a participating merchant. A server receives the user ID and PIN from the merchant and builds a probationary user account number from the user ID, and a client ID associated therewith. The user ID number is padded to a greater number of digits to form the user account number to ensure it is unique amongst many users and clients at the server. Before approving the transaction, the server ascertains whether the user account number and PIN is on record and if so, then further establishes if the user has a sufficient balance in a user sub-ledger account in a source bank account corresponding with the user account number. Periodically, a settlement is made between the source account and various merchant bank accounts.

### FIELD OF THE INVENTION

The invention relates to a method for initiating and managing an electronic transaction system for a user, more particularly an electronic payment system enabling deposit thereto and withdrawals from participating merchants and for clearance through automated financial clearinghouse systems.

### BACKGROUND OF THE INVENTION

There are groups of individuals who could benefit from electronic payment systems, but may be excluded from the usual credit card or debit card systems for one of a number of reasons including having an age less than the age of majority, lacking a credit history, or merely where individuals desire to separate their usual electronic payment means from institution-specific merchants. Institution-specific merchants include those having internal merchant services for employees and the like such as cafeterias, and provision of other goods and services.

Another aspect of electronic payment systems is that it is a typical requirement to have a physical device such as a wallet-sized card as the means for both identification of the individual and the individual's financial information. Such cards are sometimes lost with the inconvenience and risk associated therewith and additionally are simply one more item to keep track of in an ever more cluttered wallet.

It would be desirable to have an electronic payment means between specified merchants and an individual of a known group which could provide financial access without a card when desirable.

### SUMMARY OF THE INVENTION

Accordingly, in one preferred aspect, an electronic payment system is provided and which functions as a virtual smart card. A physical card or other identifier is not mandatory, although one can be accommodated. Instead, a familiar, easily recalled user-identifying number or user ID is all that is required as discussed below. The user ID need only be unique among a small population, even amongst a very large number of users contemplated in the system.

A system server is in electronic communication with one or more participating merchants. A participating merchant is authorized to provide goods and services to a specified group of users of a specified client. The participating merchant is permitted to interact with a user of the authorizing client and permit electronic transactions, the transactions including financial and non-financial transactions. The system can manage one or more clients. Participating merchants are associated and authorized for participation with only one of said clients and not others. A merchant will present a unique identification in the system despite the possibility of several merchants having common ownership or control.

In one embodiment, a user is a person within a specific group of persons who can register an identifying number which has a limited number of digits and identifies the user from other users in the specific group. The specific group is typically a client such as a school or institution. An account is created and a unique user account number is created having a more secure and greater number of digits and which incorporates the identifying number for distinguishing the user from other users in any other groups. A personal identification number (user PIN) is assigned to the user account number. Usually a single source bank account is maintained, and a database links the various users through their unique user account numbers to a fractional monetary value of the account. A sub-ledger of each user's account balance is maintained in a system separate from the banking system. For simplicity, the banking system sees one account and one account balance despite a plurality of user and virtual sub-ledger accounts.

At participating vendors or authorized merchants, at a minimum, a user need only to provide the identifying number and their user PIN. No particular physical medium is required. When the identifying number is used in an electronic transaction, it must be distinguished from other coincidentally identical identifying numbers of other clients. During a transaction, such as a withdrawal request, the merchant's location or identification, the user's identifying number and user PIN is forwarded to the system server and the corresponding client ID is identified and the unique user account number is generated. If the user account exists and the user PIN is valid then the transaction is completed.

On periodic batch intervals (such as once per day), the server queries the banking system for any deposits made to the source account to the credit of a specified user account number. The corresponding user's sub-ledger balance is updated. Upon a merchant's query such as a withdrawal request, the user's balance is checked, the query authorized, and the user's balance in the sub-ledger is debited. Multiple transactions can be made and a withdrawal request could also comprises a refund request. After a period (such at the end of the day), a settlement is made through the banking system to perform an electronic funds transfer (EFT) between the source account and all transacting merchants and the sub-ledger accounts are appropriately adjusted.

The system manages one or more databases comprising lists and cross-references of clients, users, merchants and user accounts. As discussed, clients are typically a company or a school; however a client may include a school district having several schools. Respectively, typical users would be employees or students. A school may include several types of merchants such as a third party independent vendor or discrete legal entity operating a cafeteria within a school or may include a school-operated enterprises within the school itself. The school division is preferably distinguished from the school as a “client” aspect by terms such as school tuck shop, client-managed cafeteria or school store. Each merchant would have a unique merchant ID or address. Each user belonging to a client has a unique identification number amongst the client's users and a corresponding sub-ledger user account.

By design, the users are preferably restricted in their access to merchants; users can only conduct transactions under the system with client authorized merchants, usually located on the same premises as the client. The database cross-references users, clients and merchants and particular users or groups of users can be authorized to access specific merchants. Similarly, merchants are only authorized to provide services and accept a payment request from users of the authorizing client. The client typically assigns the authorizations.

Further, the system processes both financial and non-financial transactions. For example, an asset management and student tracking module processes non-financial transactions such as quantifiable management control including for the issuance, return and loss of school text books, sports and music equipment, shop supplies, etc. A student tracking module processes attendance information and prints late slips online to provide direct and positive communication with parents via email and an interactive internet website. In such cases, the user account number is associated with additional fields including assets, such as school equipment and books, and performance characteristics including attendance and grades.

Therefore, in a broad aspect, a method for conducting electronic financial transactions comprises establishing a user account and a user account balance in one or more source accounts for each of a plurality of users associated with a client and establishing one or more merchants authorized by the client; receiving a withdrawal request from one of the plurality of users at a server on a distributed network from an authorized merchant on the distributed network, said withdrawal request including a withdrawal amount, a user-identifying number and a user PIN; establishing a probationary user account number from the received user-identifying number, a client ID corresponding to the client and padding the user-identifying number to a pre-determined number of digits, and comparing the probationary user account number to a user account number at the server to determine if the probationary user account number is a valid user account number for a user of the client and, if valid, comparing the received user PIN to the user PIN for the user account number to validate the electronic transaction.

Preferably, before completing the transaction the system further comprises establishing that the withdrawal amount does not exceed the user account balance, and if it does not, then debiting the withdrawal amount from the user account balance for the user's user account number, and periodically conducting a settlement electronic financial transaction between the at least one source bank account and a merchant bank account for the authorized merchant.

### BRIEF DESCRIPTION OF THE DRAWINGS

FIG. 1 is a flowchart of various users, merchants, clients, a banking system and a server in electronic communication as part of a cashless transaction system according to one embodiment of the invention;

FIG. 2 is a flow chart illustrating some of the elements of the server of FIG. 1 in a transaction between a user and a merchant; and

FIG. 3 is a flow chart illustrating aspects of the server and the database of users and user account numbers.

### DESCRIPTION OF THE PREFERRED EMBODIMENT

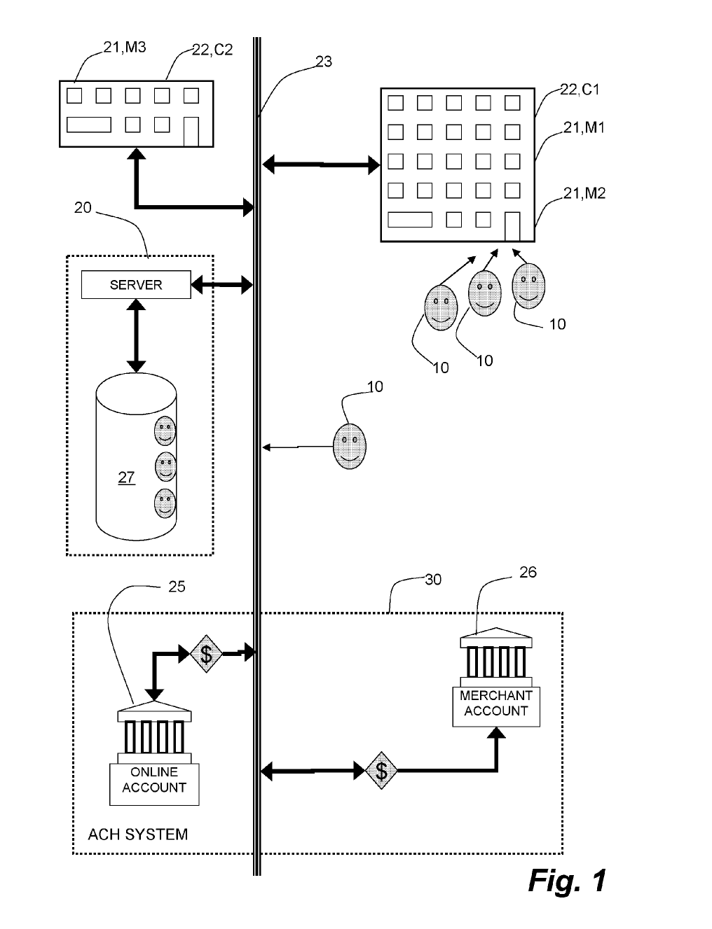

With reference to FIG. 1, in one embodiment, a system is provided for enabling cardless transactions for the tracking of assets including cashless financial transactions and tracking of physical assets and user performance characteristics. For example, in an educational context, the system enables transactions for users of the system including financial services, attendance tracking and student asset tracking such as school supplies and books. The assets are dispensed to users through authorized asset distributors. In one preferred embodiment, financial transactions are provided between user and merchants as well as in conjunction with other asset tracking functionality.

In a financial context, cashless financial transactions are enabled for users associated with a client and between those users and merchants. The merchants are asset distributors, said merchants being authorized by the client to conduct transactions with that client's users. Illustrative, but not limiting in its context, one embodiment of the invention would enable a student Smith in a first school to present an easily remembered or familiar user-identifying number (familiar ID or user ID) to a school cafeteria. Particularly with children as users, conventional cards often become lost, yet a familiar user ID can be recited from memory. Student Smith is one of a plurality of users associated with a particular client having a client identifying number or client ID, in this case the client being a school or school system, and the authorized merchant could be a school cafeteria. Student Smith would have funds as evidenced in a sub-ledger for Smith at the server. A positive balance could result from an earlier deposit such as that made by Smith or Smith's parents.

During a financial transaction in which the student user requests a withdrawal of funds, the merchant cafeteria would obtain at least this familiar user ID (being a student number or other numerical ID that could even be specified by Smith and initially registered with the system) and the student's PIN. The merchant would then electronically identify themselves to a server, such as by address or other merchant identifier or ID. Thereafter is a process of establishing if the student Smith in fact has a user account number in the system and is authorized to make the withdrawal, both by identity and that Smith has sufficient financial resources.

The combination of the user ID and the client ID enable establishing if a user, such as student Smith of the first client or school, is permitted to engage in a transaction with that client's merchant or cafeteria. Upon confirming the student Smith's PIN and if Smith has sufficient funds as evidenced in a sub-ledger for Smith, then the server can authorize the transaction. At some point in time, such as at the end of the day, the transactions, the sub-ledger balance for a source bank account and the merchant's bank account are reconciled through an automated clearinghouse system.

It is possible for a user of one client to have the same user identifying ID as a user of another client, such as another school. In order for the server to distinguish one user of one client from users of another client, each user has a user account number which has a sufficient number of digits to be unique amongst all the users of all the clients in the system. In one simple embodiment, the user account number includes the user ID and the client ID padded to a larger number of digits.

Integrity of the system is assured through assignment of this unique user account number generated from the familiar ID, the user account number being unique from any other user account number at the server regardless of the client. The user account numbers would be unique even if the same familiar ID was used by student users or employee users at different schools or places of business. Each school, or school system, would be identified as a different institution or client and the user account number would reflect the membership of the student for that client. A typical client of the present system comprises a school system having many schools, the students in the plurality of schools in the school system all belonging to the same client and having unique student ID's therein.

The user account number also ensures a secure system of asset management for all of the users including one or more asset accounts maintained in sub-ledgers in the system for tracking assets including funds. A user or some other benefactor such as a parent or the client themselves can apply credit to the user's sub-ledger for establishing a credit in the sub-ledger from which assets can be debited.

Accordingly, in greater detail, a system for conducting electronic transactions including financial transactions comprises a server 20 in communication with users 10 and authorized asset distributors such as merchants 21 (such as merchants M1,M2 . . . ) at a known institution or client 22 (such as C1) over a distributed network 23 such as the internet. Geographically, merchants 21, M! and M2 are usually located at the location of the client 22.

The server 20 manages user asset accounts and asset balances, authenticates debit requests by merchants 21 for a user 10 and, in financial transactions, would settle financial accounts between a server's source account 25 and each merchant's account 26.

The server 20 includes a database 27 for managing clients 22, users 10, merchants 21 and user accounts. Through an interactive interface or other registration process, clients 22 and one or more of the client's users 10 are recorded in the database 27. Each user 10 belonging to a client 22 has a unique use-identifying number (user ID) amongst the client's users. Each user 10 has a sub-ledger for their user account. The database cross-references users 10, clients 22 and merchants 21.

Merchants 21 are associated with a particular client 22 C1,C2 . . . . A user 10 of the client C1,C2 can include an employee 10 of a company C1, or a student 10 at a school CB or alternatively students 10,10 in a school system C2.

A user 10 can be authorized to frequent one or more merchants 21. For example, first and second merchants 21,M1 and 21,M2 and all users 10 of a first client 22,C1 are authorized to conduct financial transactions according to an embodiment of the invention. A third merchant 21,M3 is not so authorized, however this third merchant M3 can be authorized to conduct financial transactions with users 10 of a second client 22,C2.

The database 27 further comprises a user account number and user PIN to uniquely identify the user's accounts and authorize access thereto. The user account number is generated at the server 20. The user PIN may be generated and is typically changeable by the authorized user 10.

The user account number is a number having sufficient numbers of digits to enable assignment of unique numbers to every user 10,10 . . . of every client 22,C1,C2 . . . in the database 27. In most instances a suitable length of user account number is 20 digits.

A component of the user account number is the generation of a numeric user ID which is unique from other numeric ID's for the client 22. Due to the finite number of users 10 for a client 22 or institution, the numeric ID would typically be an employee number or student ID number which is familiar to the user 10 and which is assigned by the client 22 or chosen by the user 10. The familiar ID or user ID, is limited in the number of digits and therefore limited in numerical combinations, and is therefore restricted for distinguishing between users 10 in a small population. The greater number of digits of the user account number comprises a more secure and unique number amongst all users of all participating clients. The greater number of digits of the user account number incorporates the fewer digits of the user ID. The familiar ID is preferably parsable or recognizable within the final user account number. For example, a user 10 from a first school C1 can have an 8-digit student ID “12345678”. For ease of recognition of their own user account number, it is advantageous to reflect the user's 8-digit student ID as the familiar user ID and to pad it with 12 additional digits to form a 20-digit account number “987654321098 12345678” which is unique in the server.

TABLE 1

| | |
|---|---|
| User | 12345678 |
| Pad Number to larger | <<<<<<<<<<<<12345678 |
| number of digits for a | |
| unique account number | |
| A resulting account | 98765432109812345678 |
| number | |

Similarly, a 6-digit student ID “123456” for a user 10 from a second school C2 would be padded with 14 additional digits to form a 20-digit account number “98765432109876 123456”.

TABLE 2

| | |
|---|---|
| User | 123456 |
| Pad Number to larger | <<<<<<<<<<<<<<123456 |
| number of digits for a | |
| unique account number | |
| A resulting account | 98765432109876123456 |
| number | |

Preferably, the unique user number includes the familiar ID, and an indication or identification of the client 22.

TABLE 3

| | |
|---|---|
| User | 123456 |
| Client | 001 |
| Pad Number to larger | <<<<<<<<<<<001123456 |
| number of digits for a | |
| unique account number | |
| A resulting account | 98765432109001123456 |
| number | |

There are many forms of algorithms known to those of skill in the art which can provide unique account numbers from root numbers. Padding can be through masks or hashing algorithms.

In one embodiment, the padding digits may comprise a simple padding with zeros and a prefix.

TABLE 4

| | |
|---|---|
| User | 123456 |
| Client | 001 |
| Pad Number to larger | <<<<<<<<<<<001123456 |
| number of digits using | |
| simple filler for a client | |
| and a unique account | |
| number | |
| A resulting account | 10000000000001123456 |
| number having both | |
| client ID and user ID | |
| therein | |

In another embodiment, the padding digits may comprise a hash based in part upon a unique number assigned to the particular client.

TABLE 5

| | |
|---|---|
| User | 123456 |
| Client | 001 |
| Pad Number to larger | <<<<<<<<<<<001123456 |
| number of digits using | |
| an hash algorithm for a | |
| client and a unique | |
| account number | |
| A resulting account | 19472858335001123456 |
| number in which the | |
| client ID is maintained | |
| discrete from the hash | |

For financial aspects of the transactions, the server 20 is also in electronic communication with the electronic banking system such as an automated clearinghouse system ACH System 30 which is authorized to engage and settle electronic financial transactions.

The known ACH System 30 is in communication with and enables transactions between the server 20, a system or source bank account 25 and one or more merchant's bank accounts 26.

ACH Systems 30 are known to those of skill in this art. Simply, as it applies in Canada, the relevant ACH system 30 is the Automated Clearing Settlement System (ACSS) handing about 99% of the volume of transactions and the Large Value Transfer System (LVTS) which clears about 85% of the value of the transfers such as in settlements of a day's cumulative transactions. More information is available from the Canadian Payments Association at www.cdna.ca. In the US, the Federal Reserve Banks are collectively the largest automated clearinghouse operators in an ACH System 30. There are also private-sector ACH operators processing the balance of the financial transactions. More information on US ACH Systems is available at the National Automated Clearinghouse Association (NACHA) at www.nacha.org.

In one embodiment, the system limits the user's access to participating merchants. A participating merchant 21 would be a merchant authorized to receive funds from users 10 of the client 22. For example, in an education institution context, a student user 10 may be able to freely access the system for payment of various school fees 21,M1 and cafeteria fees 21,M2 of that particular educational institution 22,C1, but would not be able to access the system for a convenience store across the street. A parent would be particularly interested in such a system for controlled disbursement of funds earmarked for school expenditures only.

A participating merchant 21 has a merchant identification ID. The merchant ID is associated with a particular client institution such as 22,C1 or 22,C2 but not both.

The merchant 21 has a terminal for electronic access to the server 20. The terminal at its most elementary comprises means for entering the user numeric ID and user PIN, means for communicating the user ID, PIN and some identification of the merchant ID to the server 20. In one instance, the merchant ID is provided in the form of a static internet protocol (IP) address, which identifies the merchant 21 and by default identifies the association with a particular authorizing client 22. For example the server 20 would understand that a cafeteria merchant IP address would identify both the merchant 21 (the cafeteria) and the client 22 (the particular school in which the cafeteria was located).

More preferably, the merchant terminal comprises additional or alternate means of entry. Such alternate entry means can include magstripes, barcodes, and iris/palm-metric readers in those instances where a card is provided. Often cards are provided by a school client and which identify the student user ID. Accordingly, the system can accept the card (as identifying the user ID) and the user PIN.

The client 22, such as a particular school or commercial institution in which the merchant 21 operates, is established. Typically, it is assumed that a merchant's terminal in communication with the server 20 is a terminal of an authorized merchant 21. Therefore, a merchant ID, being identification of the merchant terminal, is looked-up or cross-referenced at the server 20 to identify its corresponding authorizing clients 22 or particular users 10 of the client. Alternatively, the merchant terminal device could transmit or otherwise communicate the identity of the client 22.

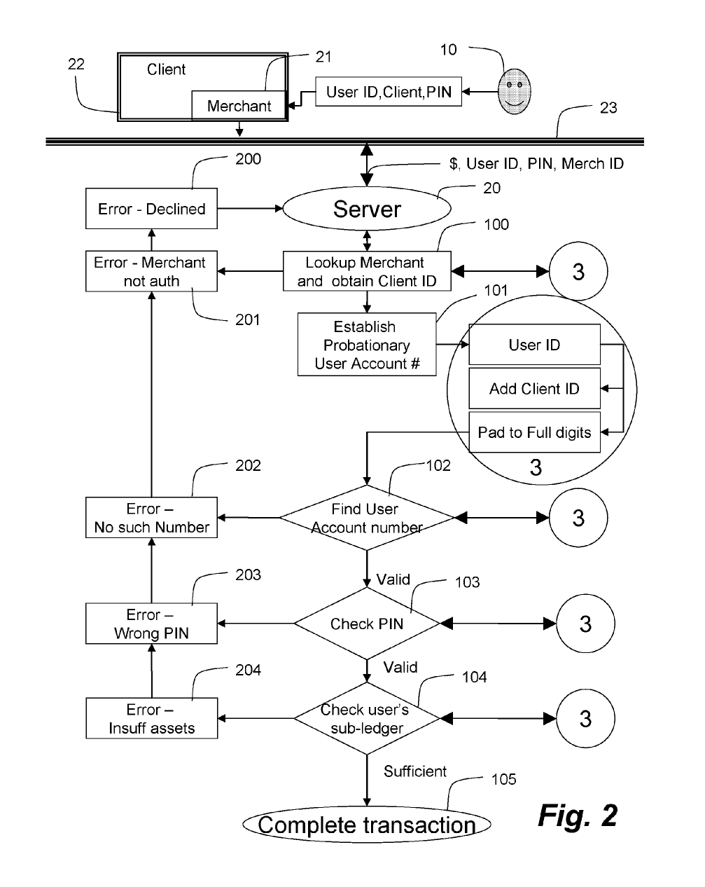

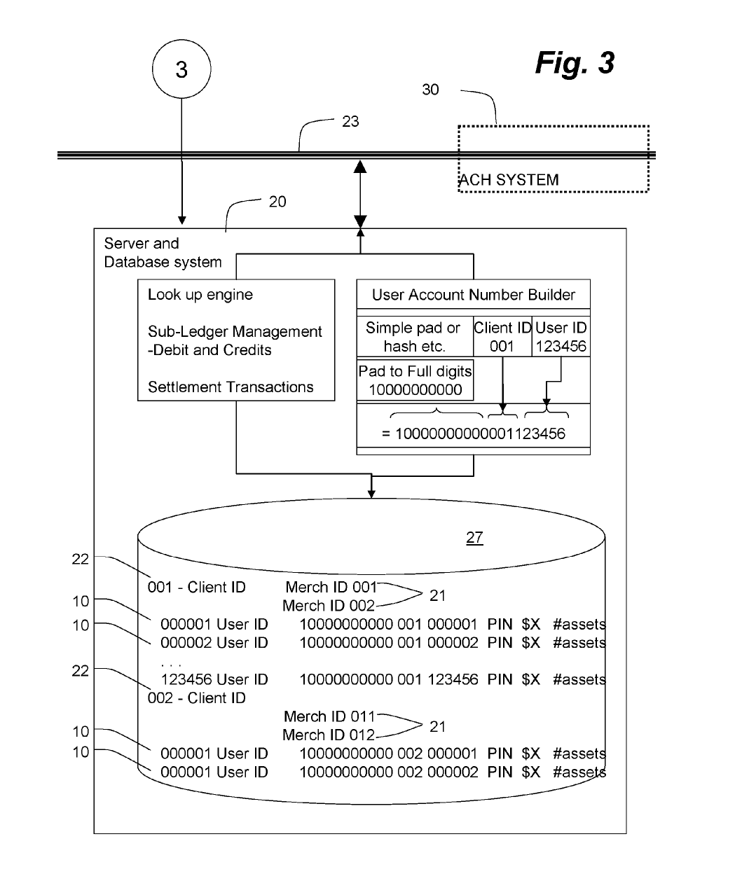

With reference to FIGS. 2 and 3, in use, the system include the server 20 communicating over a distributed network 23 with at least one client 22, and at least one merchant 21. Detailed in FIG. 3, the server 20 maintains a database 27 of one or more clients 22, one or more merchants 21, a plurality of users 10 and assets and additional details therefor. One more clients 22 are registered with the system and each are assigned a unique client ID. Users 10 of each client 22 are registered, possibly in a bulk registration initiated by the client 22 or as individual users 10 indicate their interest in accessing the system.

Users 10 are provided with an access interface (not shown) to the distributed network 23 for registering or amending their user account information. Users preferably choose a familiar number as their user ID, such as their student number. The system could suggest their student ID and provide an option to enter an alternate ID which is compared against other users of the client to ensure it is unique. A user's personal identification number PIN is either initially assigned and subsequently changed by the user 10 or the user is prompted to enter a desired user PIN.

The system generates a unique user account number for the user in the database 27 of all clients 22. The familiar ID is padded and generated as necessary to the greater number of digits as the user account number used to uniquely identify the user. In some instances, a device may also be generated including a magnetic card, or to obtain biometric data for association with the user account.

The system maintains at least one source bank account 25 (FIG. 1). The user account number is associated with a sub-ledger maintained in the database which represents the user's balance in the source account. There can also be sub-ledger for non-financial assets such as academic marks, books or attendance for example.

Users or benevolent third parties can make deposits to the financial sub-ledger associated with the user account number through personal online banking portals; said deposits being directed to the system's source account and credited to the sub-ledger which is registered with the ACH System. The system is electronically linked to participating merchants 21 for accepting a withdrawal request from a user.

For non-financial transactions, the sub-ledger may monitor quantity and serial numbers of assets lent or returned or tracking of the types of assets of interest.

Returning to FIG. 2, when a user 10 requests a good or service from a participating merchant 21, the merchant forwards a withdrawal request to the server 20 including the amount of the transaction, an identification of the merchant 21, the user's user-identifying ID number or full account number and the user PIN. The server 20 determines if the merchant 21 is authorized to conduct the requested financial transaction, whether the user 10 is a valid user of the client 22 and if the particular user 10 has the sub-ledger balance.

More particularly, at block 100 the server 20 uses the received merchant ID and looks up a corresponding client ID in the database 27 (see routing to FIG. 3 at 3). While typically an unauthorized merchant would not have the access to the server 20 at all, if the merchant 21 is found not to be authorized, or perhaps is no longer authorized, then an error is generated at 201 and the merchant 21 receives back a declined error message at block 200.

At block 101 the server 20 then establishes a probationary user account number from the received user-identifying number or user ID, a client ID corresponding to the client 22 and padding the user-identifying number to a pre-determined number of digits. Using one of many possible algorithms, the user ID is combined with the client ID and is padded to the full number of digits.

At block 102, the server compares the probationary user account number with user account numbers looked-up at the server to determine if the probationary user account number is a valid user account number for a user 10 of the client 22. If the user account number is not found then the user 10 may not be authorized, does not exist or perhaps is a user of another client and an error is generated at block 202 and the merchant 21 receives back a declined error message at block 200.

If the user account number is found, it is a valid number and at block 103 the server compares the received user PIN to the user PIN for the user account number to validate the electronic transaction. At block 203, if the PIN does not match then the error is noted and the merchant 21 receives back a declined error message at block 200.

At block 104, if the user PIN corresponds with the user account number then the server 20 checks the user account number's sub-ledger account for sufficient funds to meet the withdrawal request. If the withdrawal amount exceeds the user's account balance, then at block 204 it is known there are insufficient funds and the merchant 21 receives back a declined error message at block 200.

If the quantum or withdrawal amount does not exceed the user account balance, then at block 105 the transaction is completed wherein the sub-ledger is debited and periodically at some point, a settlement electronic financial transaction is conducted between the at least one source bank account 25 and the merchant's bank account 26.

In the above embodiment, the user 10 can conduct the transaction without necessarily possessing a physical card. The server 20 need only be able to ascertain the authority of the merchant 21 and the user 10 to conduct a transaction. In one scenario, the server determines if the user ID and the merchant ID are associated with a common client 22. In the preferred scenario as shown in FIGS. 2 and 3, the familiar user ID and the merchant ID are submitted to the server 20 to establish the authorizations necessary to permit the transactions and to verify the presenting individual's right to debit the user's sub-ledger.

If authorized, the transaction is completed at block 105 and then the merchant 21 is advised that the transaction was approved. Periodically, the system conducts a settlement electronic financial transaction between the source bank account 25 and the bank account 26 of the authorized merchant 21. The periodicity is generally dependent upon economies of substantially real time or batch settlements. Typically settlement can occur at the end of each business day.

Settlement comprises accessing the ACH System for transferring an amount, typically the transaction amount, to the merchant's account 21. The user's account balance in the sub-ledger is debited. Further, any deposits to the user's account are acknowledged and the ACH System debits the benefactor or payor's account to the credit of the systems' source account and the user's account balance in the sub-ledger is credited.

Options for assigning a familiar user ID include: pre-determination and specification of the familiar user ID by the client 22 for their plurality of users 10, auto-generating familiar ID's by the server 20, and preferably selection of user ID by the user 10 themselves, subject to a uniqueness confirmation. A user's selection of a user ID would typically include their employee number, student identification number or drivers license number.

As discussed above, the cashless transaction system is integrated with the banking systems. The system functions as a virtual smart card. The system enhances known prepaid cash or debit cards (such as prepaid phone cards) in that: there are no expiry dates or preset limits, there are no age restrictions or credit application procedures; and maintenance of the account balance is dynamic. This system and the banking system process all monetary and non-monetary transactions either online or offline, at the point-of-sale (POS). Users 10 can also deposit money into their user account at the POS, with telephone banking, at ATMs or over the Internet through most financial institutions.

Through an interactive interface to the server 20, a user 10 can register virtually any identifying user ID number they choose to obtain a user account. As discussed, to use the user account for a transaction, a user 10 need only provide their user ID. The user 10 does not require the use of any physical medium, however, optionally, the means for identifying the user 10 can take on any physical form to communicate the familiar user ID or the whole of the user account number including cards magstripes, barcodes, and biometric means such as iris scanners, fingerprint and palm-metric readers.

To expand the range of authorized merchants 21, the system can be integrated with third party Internet based shopping cart applications, Windows® based hand-held devices and Windows® based POS software.

The interface to the server 20 is interactive, which allows users 10 to register their user accounts and to view of all of their monetary and non-monetary transactions in real time. In such cases, the user account number is associated with additional fields including assets, such as school equipment and books, and performance characteristics including attendance and grades.

Additional functionality of the system includes providing users and authorized third parties such as parents of student users with direct positive confirmation of attendance, issued school assets and purchases. An asset management and student tracking module can process non-financial transactions such as quantifiable management control including for issues, returns and losses of school text books, sports and music equipment, shop supplies, etc. A student tracking module processes attendance information and prints late slips online to provide direct and positive communication with parents via email and an interactive internet website. For example, in this optional embodiment, a teacher's terminal for accessing the server 20 would have an equivalent merchant ID and clearly represent the school client ID as well. A teacher can enter values for the student under the student's user ID. The values which represent attendance missed, book loans and the like. Each entry represents management of an asset which is managed in a sub-ledger of the student in a manner similar to that of the financial transactions. Each sub-ledger entry is associated with the full user account number in the system but is merely accessed using the user ID from a terminal associated with the particular client 22.

What is claimed is:

1. A method for conducting electronic financial transactions comprising:
maintaining at least one source bank account which is electronically linked for accepting transaction requests, including one or both of electronic withdrawal and deposit requests, and one or more of deposit to and withdrawal from at least one merchant bank account;
maintaining a database system of one or more clients, each client having a unique client ID number, a plurality of users authorized to electronically access the at least one source bank account, each user having a unique user account number in the database, a user PIN and a user account balance,
establishing a unique user account number in the database system for each user including a user-identifying number being unique amongst the plurality of users of the client, and padding to a greater and pre-determined number of digits so that the user account number is unique from all others in the database; and
maintaining in the database system one or more authorized merchants that are authorized by each client to receive a withdrawal request from users of that client; and
for each electronic transaction,
receiving a transaction request from a merchant for a user including an amount, the user-identifying number and the user PIN and at least a merchant identifier;
establishing the client ID number associated with the identified merchant;
establishing a probationary user account number from the received user-identifying number, the client ID number and padding to the pre-determined number of digits, and
comparing the probationary user account number to the user account numbers in the database to determine if the probationary user account number is a valid user account number and, if valid,
comparing the received user PIN to the user PIN for the user account number to validate the transaction and, if validated,
completing the electronic transaction for the transaction amount.

2. The method of claim 1 wherein the transaction request is a withdrawal request, and prior to conducting the electronic transactions, further comprising:
establishing that the quantum of the withdrawal request does not exceed the user account balance, and if it does not, then
debiting the quantum from the user account balance for the user's user account number, and
periodically conducting a settlement electronic financial transaction between the at least one source bank account for one or more users and the authorized merchant's merchant bank account.

3. The method of claim 1 wherein prior to conducting electronic financial transactions, further comprising specifying the user-identifying number by the client.

4. The method of claim 1 wherein prior to conducting electronic financial transactions, further comprising specifying the user-identifying number by the user.

5. The method of claim 1 further comprising identifying the client ID number using one or more digits within the user account number.

6. The method of claim 1 wherein the user account number includes the user-identifying number and the client ID number.

7. The method of claim 1 wherein the receiving of the withdrawal request further comprises an identification of the authorized merchant.

8. The method of claim 1 wherein the receiving of the withdrawal request further comprises identification of the client ID number.

9. The method of claim 1 wherein the receiving of the transaction request further comprises an indication of a merchant address and, prior to establishing a probationary user account number, further comprising looking up the client ID number corresponding to that address for.

10. The method of claim 9 wherein the address is an IP address.

11. The method of claim 1 wherein the merchant is also the client.

12. The method of claim 1 further comprising managing each user account balance as a sub-ledger balance within the at least one source account.

13. The method of claim 1 further comprising prior to conducting financial transactions further comprising crediting the user's account through an electronic financial transaction to the credit of the at least one source bank account.

14. The method of claim 1 wherein the merchant is located at the client.

15. The method of claim 14 wherein the client is also the merchant.

16. The method of claim 1 wherein the users are students and the client is a school.

17. The method of claim 16 wherein the merchant is a service located in the school.

18. The method of claim 16 wherein the merchant is an independent entity discrete from the school.

19. The method of claim 16 wherein the school is also the merchant.

20. The method of claim 1 further comprising tracking of the attendance of the user at the client.

21. The method of claim 1 further comprising tracking of non-financial assets obtained and returned to the merchant.

22. A method for conducting electronic financial transactions comprising:
establishing a user account and a user account balance in one or more source accounts for each of a plurality of users associated with a client and establishing one or more merchants authorized by the client;
receiving a transaction request from one of the plurality of users at a server on a distributed network from an authorized merchant on the distributed network, said transaction request including a quantum, a user-identifying number and a user PIN;
establishing a probationary user account number from the received user-identifying number, a client ID corresponding to the client and padding the user-identifying number to a pre-determined number of digits, and
comparing the probationary user account number to a user account number at the server to determine if the probationary user account number is a valid user account number for a user of the client, and if valid
comparing the received user PIN to the user PIN for the user account number to validate the electronic transaction, and
adjusting the user account balance by the quantum.

23. The method of claim 22 wherein the transaction request is a withdrawal request and wherein adjusting of the user account balance further comprises:
establishing that the quantum of the withdrawal request does not exceed the user account balance, and if it does not, then debiting the quantum from the user account balance for the user's user account number, and
periodically conducting a settlement electronic financial transaction between the at least one source bank account and a merchant bank account for the authorized merchant.

24. A method for conducting asset management transactions comprising:
maintaining at least one user-asset account which is electronically linked for accepting a debit request from, and deposit request to, at least one asset-distributing entity account; maintaining a database system of one or more clients, each client having unique client ID, a plurality of users authorized to electronically access the at least user-asset account, each user having a unique user account number in the database, a user PIN and a user account ledger,
establishing a unique user account number in the database system for each user including a user-identifying number being unique amongst the plurality of users of the client, and pad with additional numbers to a greater and pre-determined number of digits so that the user account number is unique from all others in the database; and
maintaining in the database system one or more authorized distributing entities that are authorized by the client to distribute assets to a user upon receipt of an asset debit request from that user; and
for each electronic transaction,
receiving an asset change request from a distributing entity for a user including a quantum, the user-identifying number and the user PIN and at least an distributing entity ID;
looking up the client ID in the database system for the client which authorized the distributing entity;
establishing a probationary user account number from the user-identifying number, the client ID and padding to the pre-determined number of digits, and
comparing the probationary user account number to the user account numbers in the database to determine if the probationary user account number is a valid user account number and, if valid,
comparing the PIN to the PIN for the valid user account number to validate the transaction and, if validated,
adjusting the user account balance by the quantum.

25. A system for conducting electronic financial transactions comprising:
a server on a distributed network;
at least one source bank account accessible on the distributed network through an ACH system;
at least one database accessible by the server and having a user account number and a user account balance in the at least one or more source bank accounts for each of a plurality of users associated with a client of one or more clients, each user account number comprising
a user-identifying number, a client ID and padding numbers to a pre-determined number of digits;
one or more merchants accessible on the distributed network and known by the server, each merchant being associated with and authorized by client, each merchant capable of forwarding a transaction request from one of the plurality of users for receipt at the server, said transaction request including a quantum, a user-identifying number and a user PIN;
one or more merchant bank accounts accessible on the distributed network through an ACH system;
a user account generator for generating a probationary user account number from the user-identifying number received from the merchant, a client ID obtained from the database which corresponds to the merchant and padding the user-identifying number to a pre-determined number of digits, and
a validator for comparing the probationary user account number to one of the plurality of user account numbers at the server to determine if the probationary user account number is a valid user account number for a user of the client, and if valid comparing the received user PIN to the user PIN for the user account number to validate the electronic transaction; and
a user account balance manager for adjusting the user account balance in accordance with the transaction request by the quantum.
